(19) United States
(12) Patent Application Publication
(10) Pub. No.: US 2010/0208931 A1
(43) Pub. Date: Aug. 19, 2010

(54) Structure for an earphone

(76) Inventor: Nie Hao, Dongguan City (CN)

Correspondence Address: YH CHAN, 42 PIN OAKS DRIVE, PHOENIXVILLE, PA, 19460, US

(21) Appl. No.: 12/686,385

(22) Filed: Jan. 13, 2010

(30) Foreign Application Priority Data
Feb. 18, 2009 (CN) 200920009727.0

(51) Int. Cl. H04R 25/00

(52) U.S. Cl. 381/372

(57) ABSTRACT

The present invention discloses a structure for an earphone which comprises an ear sleeve, a front chamber, a rear chamber and a loudspeaker disposed in the rear chamber. The front chamber has a front end which is connected with the ear sleeve and a rear end which is connected with the rear chamber. The front chamber is made of metal or plastic. The rear chamber is made of wood material. The present invention has the following beneficial effects: The front chamber is made of metal or plastic so that the sound quality of the treble range of the earphone is effectively enhanced. The rear chamber is made of wood material which has a relatively high hardness and density so that it may better absorb standing waves of low-frequency sounds, and therefore rendering the low-frequency sounds clearer and stronger, thus enabling users to enjoy better music. Besides, the structure of the earphone is simple, small in size and beautiful, comfortable to use and stylish.

### BACKGROUND OF THE INVENTION

The present invention relates to earphones and more particularly pertains to a structure for an earphone.

Nowadays, earphones are indispensable in people's daily life. With continuous advancements in scientific technologies, demand on quality of earphones has become higher and higher. Such a trend brings along a corresponding question: How to enable earphones to deliver the best sound quality?

The utility model patent titled “In-ear earphones” under publication number CN1929692A published on 28 Mar. 2007 discloses an in-ear earphone comprising a front casing, a rear casing, an earplug and a speaker. The front casing and the rear casing are connected with each other to form a receiving chamber for receiving the speaker. The ear plug and the front casing are connected with each other. The front casing and the rear casing are made of wood. Although it delivers a relatively outstanding sound quality, there is still a possibility to enhance the sound quality further. According to numerous experiments, it has been found that front casings in the same shape yet made of different types of wood impose only minute and negligible effects in the sound quality of the bass range but significant effects in the treble range.

### BRIEF SUMMARY OF THE INVENTION

In view of the aforesaid disadvantages now present in the prior art, the present invention provides a structure for an earphone which is simple in structure and delivers better sound quality.

To attain this, the present invention provides the following technical proposal:

A structure for an earphone which comprises an ear sleeve, a front chamber, a rear chamber and a loudspeaker disposed in the rear chamber. The front chamber has a front end which is connected with the ear sleeve and a rear end which is connected with the rear chamber. The front chamber is made of metal or plastic. The rear chamber is made of wood material.

The wood material is sandalwood, rosewood, mahogany, walnut or other wood material with a relatively high hardness and density.

The rear chamber is in shape of a semi-sphere or a cylinder.

The present invention has the following beneficial effects: The front chamber is made of a material which is beneficial to the sound quality of the treble range such as metal or plastic so that the sound quality of the treble range of the earphone is effectively enhanced. The rear chamber is made of a wood material which has a relatively high hardness and density so that it may better absorb standing waves of low-frequency sounds, and therefore rendering the low-frequency sounds clearer and stronger. The overall sound quality of the earphone may be enhanced, thereby enabling users to enjoy better music. Besides, the structure of the earphone is simple. The rear chamber of the earphone is in shape of a semi-sphere or a cylinder. It is small in size and beautiful, comfortable to use and stylish.

The present invention is further explained in detail with the accompanying drawings and a preferred embodiment.

### BRIEF DESCRIPTION OF THE DRAWINGS

FIG. 1 shows the structure of the present invention.

FIG. 2 shows the 3-D structure of the present invention as shown in FIG. 1.

### DETAILED DESCRIPTION OF THE INVENTION

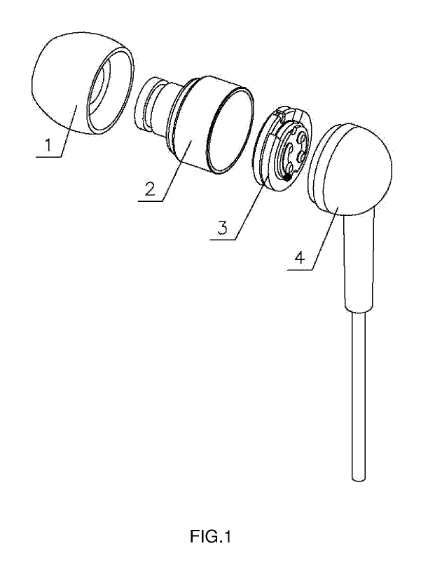

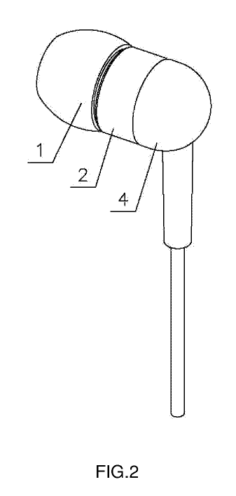

As illustrated in FIGS. 1 and 2, the present embodiment provides a structure for an earphone which comprises an ear sleeve 1, a front chamber 2 made of metal, a rear chamber 4 made of sandalwood and in shape of a semi-sphere, and a speaker 3 disposed in the rear chamber 4. The front chamber 2 has a front end which is connected with the ear sleeve 1 and a rear end which is connected with the rear chamber 4. In other embodiments, the front chamber 2 may be made of plastic. The front chamber 2 made of different materials impose only a minute and negligible effect in the sound quality of the bass range but a significant effect in the treble range. Therefore, the present front chamber 2 is made of a material which is beneficial to the sound quality of the treble range such as metal or plastic so that the sound quality of the treble range of the earphone is effectively enhanced. The rear chamber 4 may be made of rosewood, mahogany, walnut or other wood material with a relatively high hardness and density. The rear chamber 4 made of a wood material with a relatively high hardness and density may better absorb standing waves of low-frequency sounds, and therefore rendering the low-frequency sounds clearer and stronger, thus enabling users to enjoy better music.

Other structures for an earphone which adopts the same or similar structures according to the above embodiment of the present invention are within the scope of protection of the present invention.

What is claimed is:

1. A structure for an earphone which comprises an ear sleeve, a front chamber, a rear chamber and a loudspeaker disposed in the rear chamber, and the front chamber has a front end which is connected with the ear sleeve and a rear end which is connected with the rear chamber, characterized in that the front chamber is made of metal or plastic, and the rear chamber is made of wood material.

2. The structure for an earphone as in claim 1, wherein the wood material is sandalwood, rosewood, mahogany, walnut or other wood material with a relatively high hardness and density.

3. The structure for an earphone as in claim 1, wherein the rear chamber is in shape of a semi-sphere or a cylinder.
